(19) United States
(12) Patent Application Publication
(10) Pub. No.: US 2006/0010236 A1
(43) Pub. Date: Jan. 12, 2006

(54) Usage-based methodology for providing web services

(75) Inventors: Colin J. Meiser, Irving, TX (US); Jason A. Salcido, Flower Mound, TX (US); Keeley L. Weisbard, Frisco, TX (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, ARMONK, NY (US)

(21) Appl. No.: 10/865,019

(22) Filed: Jun. 10, 2004

(51) Int. Cl. G06F 15/16

(52) U.S. Cl. 709/226

(57) ABSTRACT

A method for providing usage-based Web services can include the step of identifying a desired usage level at which a Web service is to be provided to a requestor before providing the Web service. A request for the Web service can be received from the requestor. Resources necessary to achieve the usage level can be determined. The Web service can be responsively provided in a dynamic fashion based upon the usage level.

### BACKGROUND

1. Field of the Invention

The present invention relates to the field of Web services and, more particularly, to a usage-based methodology for providing Web services.

2. Description of the Related Art

As the Internet becomes increasingly pervasive in our daily lives, the use of software services, called Web services, within Internet-connected computing devices has increased in corresponding fashion. Web services, which are sometimes called application services, are services that are made available from a business's Web server for Web users or other Web-connected programs. Users can access Web services directly from a central server or through a peer-to-peer arrangement. Some Web services can communicate with other services, thereby exchanging procedures and data with one another. Often these data exchanges are aided by a class of software known as middleware.

One challenge that Web service providers currently face involves predicting and subsequently constructing an appropriate hardware infrastructure to satisfy the needs of its customer base. Because the infrastructure can be a predominant cost incurred by the Web service provider, a provider that surmounts this challenge in a cost-effective manner can have a significant market advantage over competing service providers.

To determine an appropriate infrastructure a service provider must assess the computing resources necessary to handle its customer's requirements. The service provider can then construct an infrastructure capable of handling these requirements considering present and future needs of its customer base as well as expected growth patterns. Once the infrastructure has been constructed, the service provider must correctly allocate the resources of the infrastructure in accordance with the needs of its customer base.

Even assuming that a suitable infrastructure exists, properly allocating the resources of this infrastructure can be difficult. Service providers must consider that many different service requesters can simultaneously submit requests for Web services. Each request, however, can consume limited hardware resources needed for request processing. Moreover, different usage patterns can have significantly different effects on overall resource consumptions. Further, different service requestors can have different performance needs. For example, a service requestor using a Web service for real-time processing has vastly different performance needs than a service requestor using the same Web service for batch processing.

Presently, no conventional technologies exist that permit Web service providers to accurately predict real-time usage requirements for its services. Accordingly, properly establishing a Web service infrastructure can involve many assumptions based upon historical models showing previous and/or hypothetical access patterns. These patterns, however, can dynamically shift based upon time of day, network externalities, cyclic bottlenecks, and the like. As a result, Web service providers often either construct an inadequate infrastructure resulting in customer dissatisfaction or construct an overly robust infrastructure resulting in unnecessary expense.

Additionally, charges for Web services are not directly linked to resources expended in providing the services, thereby making it difficult for the service providers to allocate resources in a manner commensurate with revenue received for providing the services. More specifically, Web service providers typically charge for services on a per-use basis and/or on a subscription basis, where a subscription permits access to the Web service for a specified period.

### SUMMARY OF THE INVENTION

The present invention provides a method, a system, and an apparatus for providing usage-based Web services. More particularly, a service provider can require that users register before services are provided. Registration can include a step where a user provides usage level information. The service provider can use usage level information to determine resources needed to fulfill customer requirements, thereby adjusting a Web service infrastructure in accordance with the determined resource needs. Users usage patterns can be monitored by the service provider to assure that actual usages are commensurate with the registered usage levels. Charges for Web services can be based at least in part upon the usage levels.

One aspect of the present invention can include a method for providing usage-based Web services. The method can include the step of identifying a desired usage level at which a Web service is to be provided to a requestor. A request for the Web service can be received from the requestor. Resources necessary to achieve the usage level can be determined. The Web service can be responsively provided in accordance with the usage level.

It should be noted that the invention can be implemented as a program for controlling a computer to implement the functions described herein, or a program for enabling a computer to perform the process corresponding to the steps disclosed herein. This program may be provided by storing the program in a magnetic disk, an optical disk, a semiconductor memory, any other recording medium, or distributed via a network.

Another aspect of the present invention can include a system for providing usage-based Web services. The system can include a plurality of resources used to provide Web services, a registrar, and a usage tracker. The registrar can register users before providing Web services to the users, wherein each user is required to specify a usage level during registration. The usage tracker can compare resources consumed by users against corresponding usage levels. In the system, a cost for using the Web services can depend upon the usage level of the user.

### BRIEF DESCRIPTION OF THE DRAWINGS

There are shown in the drawings, embodiments that are presently preferred; it being understood, however, that the invention is not limited to the precise arrangements and instrumentalities shown.

FIG. 1 is a schematic diagram illustrating a system for providing usage-based Web services in accordance with an embodiment of the inventive arrangements disclosed herein.

FIG. 2 is a flow chart illustrating a method for providing usage-based Web services in accordance with an embodiment of the inventive arrangements disclosed herein.

FIG. 3 is a flow chart illustrating a method for a Web service provider to predict usage requirements of customers in accordance with an embodiment of the inventive arrangements disclosed herein.

### DETAILED DESCRIPTION OF THE INVENTION

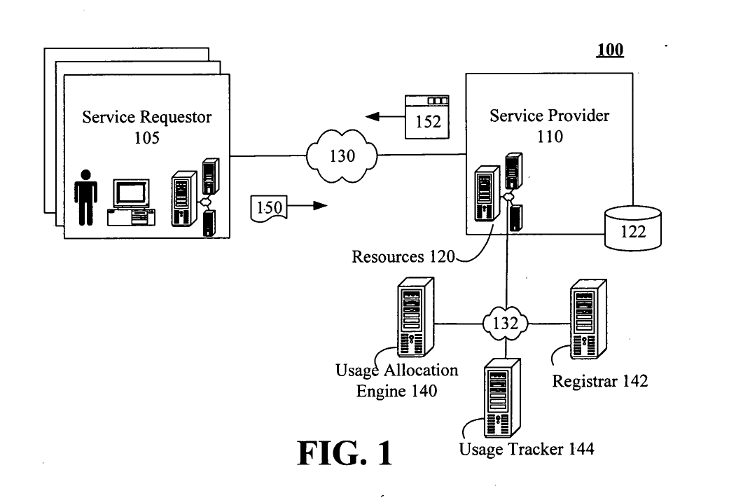

FIG. 1 is a schematic diagram illustrating a system 100 for providing usage-based Web services in accordance with an embodiment of the inventive arrangements disclosed herein. The system 100 can include at least one service requestor 105 and a service provider 110 communicatively linked via a network 130, where the service provider 110 can provide one or more Web services 152 to the service requestor 105.

The service requestor 105 can be an individual, an organization, a computing device, a computer network, another Web service, and/or any entity that utilizes the Web service 152 of the service provider 110.

The service provider 110 can utilize a services infrastructure containing a plurality of resources 120. The resources 120 can represent any computing resource or group of computing resources including, but not limited to, central processor unit (CPU) cycles, input/output (I/O) channel capacity, data transmission capacity, application usages, and the like. When the Web service 152 is provided, a portion of the resources 120 can be consumed.

Each service requestor 105 can register with the service provider 110. Registration can place requestor-specific information in a data store 122 accessible by the service provider 110. The requestor-specific information can include a usage level 150 at which the service requestor 105 expects to use the Web service 152.

In one embodiment, the usage level 150 can include a myriad of different criteria such as time of day for use, frequency of use, type of use, quantity of data to be processed by the Web service 152, average expected response time for the Web service 152, maximum acceptable processing delay when receiving the Web service 152, and the like. In another embodiment, the usage level 150 can be a qualitative assessment of usage or a series of qualitative assessments based upon posed questions. For example the usage level 150 can include one or more selections from household verses business usage, real-time verses batch usage, light verses heavy usage, delay tolerant verses delay intolerant usage, and the like.

The resource service provider 110 can use the usage level 150 to determine a quantity of resources 120 that will be needed to provide the service 152 to the service requestor 105. Cost for providing the Web service 152 can vary substantially based upon the usage level 150. In one embodiment, the service provider 110 can provide the service requestor 105 with one or more options and associated option costs. For example, one option associated with an increased cost can automatically upgrade a usage level when resources 120 are plentiful. One option associated with decreased cost can automatically downgraded a usage level when resources 120 are scarce.

In one embodiment, the service provider 110 can include a registrar 142, a usage allocation engine 140, and/or a usage tracker 144. The registrar 142 can be used to register the service requestor 105 with the service provider 110. The registrar 142 can also provide an interface through which the service requestor 105 and/or the service provider 110 can edit registration information of the data store 122.

In one arrangement, the usage allocation engine 140 can determine the resources 120 necessary to achieve the usage level 150. In another arrangement, the usage allocation engine 140 can determine the resources 120 that are available for handling requests. The usage allocation engine 140 can further allocate resources to users based upon the usage level 150 and/or the available resources 122 for handling requests.

In a particular embodiment, the usage allocation engine 144 can dynamically adjust usage levels as available resources change. For example, when insufficient resources 120 exist to provide services at current usage levels, selective ones of these services levels can be downgraded to free up resources 120. In another example, the usage allocation engine 140 can acquire additional resources 120 from third party providers whenever insufficient resources 120 exist. In still another example, when surplus resources 120 are available, the usage allocation engine 140 can selectively upgrade service levels to improve services provided to associated service requestors 105.

The usage tracker 142 can track actual resource consumptions incurred in providing the Web service 152. In one embodiment, the usage tracker 142 can compare resources consumed by users against corresponding usage levels of the consumers. When the consumed resources are out of scope with the corresponding usage levels, the usage tracker 142 can trigger the service provider 110 to take corrective actions. Corrective actions can include restricting resources 120 for a particular service requestor 105, increasing the usage level of the service requestor 105, discontinuing service to the service requestor 105, charging the service requestor 105 an additional amount for excessive resource 120 consumption, grant the service requestor 105 a credit for conservative resource 120 usage, and the like.

It should be appreciated that the arrangements shown in FIG. 1 are for illustrative purposes only and that the invention is not limited in this regard. The functionality attributable to the various components can be combined or separated in a different manner than those illustrated herein. For instance, the usage allocation engine 140 and the usage tracker 144 can be implemented as a single component in another arrangement of the present invention.

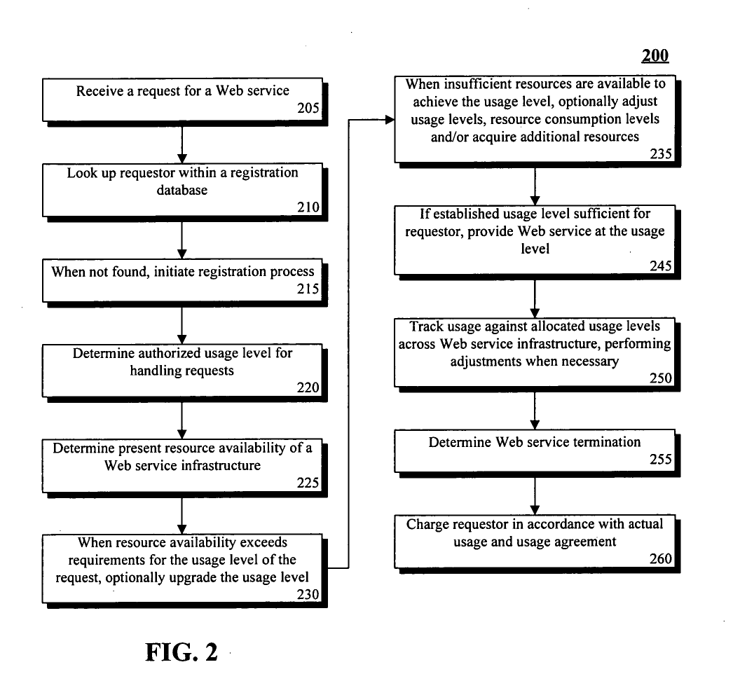

FIG. 2 is a flow chart illustrating a method 200 for providing usage-based Web services in accordance with an embodiment of the inventive arrangements disclosed herein. In one embodiment, the method 200 can be performed in the context of the system 100 of FIG. 1. The method 200, however, is not limited in this regard and can be utilized in the context of any Web service providing system.

The method 200 can begin in step 205, where a request for a Web service can be received. In step 210, requestor service information can be looked up using a registration database to determine a level of service at which the Web service is to be provided. In step 215, when no service information is found in the registration database, a registration process for the requestor can be initiated. In step 220, an authorized usage level can be determined for handling the request.

In step 225, present resource availability of the Web service infrastructure can be determined. In step 230, when resource availability exceeds the requirements for the usage level of the request, the usage level of the requestor can be optionally upgraded. The upgrade can depend upon options selected by the requester during the registration process. For example, the Web service provider can charge an additional fee for the ability to dynamically upgrade service level when surplus resources are present. In another example, the upgrade can depend upon requestor status, where a provider can enact a loyalty program that rewards requestors with service level upgrades based upon requestor status.

In step 235, when insufficient resources are available to achieve the usage level, the usage level of the requestor can be downgraded to a lower usage level that can be provided using available resources. In one embodiment, a discount can be granted to the requestor whenever a downgrade in usage level occurs.

In another situation, the provider can dynamically adjust resource consumption levels of other requestors in order to free up resources to handle the current request at the designated usage level. For example, previous requestors currently using infrastructure resources may have received usage upgrades. These upgrades can be revoked to free up resources for the most recent request.

In still another situation, the provider can acquire additional resources to handle the request at the designated level. For example, when a needed resource is bandwidth, the provider can dynamically purchase needed bandwidth from a communication provider to supplement provider owned and/or leased bandwidth. It should be appreciated that any combination of downgrading resource levels, adjusting resource consumption levels, and/or acquiring additional resources can be utilized in step 235.

In step 245, if the established usage level is sufficient for the requestor, Web service(s) can be provided to handle the request at the usage level. If the provider cannot provide a Web service at a sufficient level, a message to this affect can be provided to the requestor. In step 250, the provider can track usage against allocated usage levels across the Web service infrastructure, performing adjustments when necessary. Adjustments to usage levels can affect the cost that requestors pay for the Web services. In step 255, the provider can determine that the Web service(s) has been terminated. Termination can represent process completion, requestor cancellation, automatic termination by the provider due to excessive resource consumption, and the like. In step 260, the requestor can be charged in accordance with usage level, actual usage, and/or in accordance with the terms of any usage agreements between the requestor and the provider.

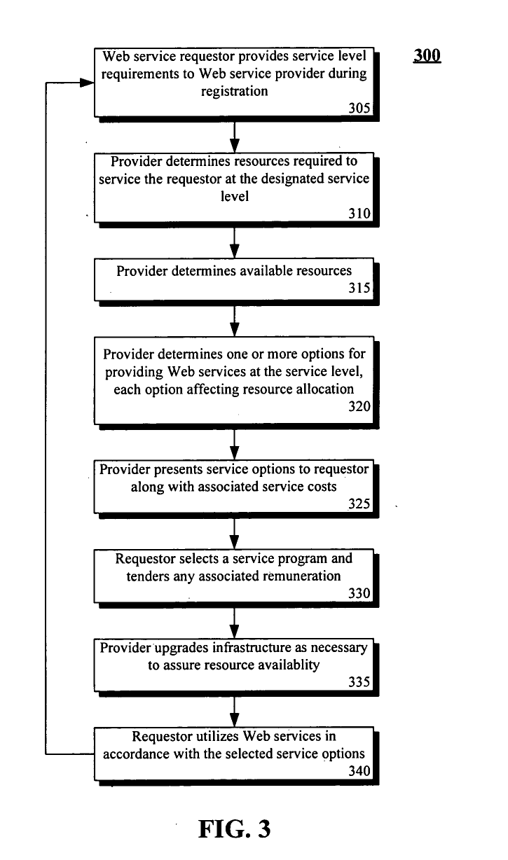

FIG. 3 is a flow charat illustrating a method 300 for a Web service provider to predict usage requirements of customers in accordance with an embodiment of the inventive arrangements disclosed herein. In one embodiment, the method 300 can be performed in the context of the system 100 of FIG. 1. The method 300, however, is not limited in this regard and can be utilized in the context of any Web service providing system. In another embodiment, the utilization of Web services shown in step 340 of FIG. 3 can be processed in accordance with method 200 of FIG. 2. The method 300, however, is not limited in this regard and requestors can utilize Web services in any usage-based fashion.

The method 300 can begin in step 305, where a Web service requestor can provide a service level requirement to the Web service provider during a registration process. In step 310, the provider can determine resources required to service the requestor at the designated service level. In step 315, the provider can determine resources currently available in the Web service infrastructure. In step 320, the provider can determine one or more options for providing the Web services at the designated service level. Particular ones of these options can require the provider to upgrade the Web service infrastructure. Prices associated with each option can be determined in light of anticipated costs incurred by the provider. In particular embodiments, such as those requiring infrastructure upgrades, time frames can be linked to the options, where the requested service may not be available until a designated time.

In step 325, the provider can present the service options to the requestor along with associated service costs. In step 330, the requestor can select a service program. This selection can require the requestor pre-pay for services and/or contract to receive the services from the provider for a set period. In step 335, the provider can upgrade the Web service infrastructure as necessary to assure resource availability. In step 340, the requestor can utilize Web services in accordance with the selected service options. Penalties can be imposed whenever the usages of the requestor exceed the contracted usage levels. Further, the requestor can negotiate new service terms with the provider at any point, causing the method to loop to step 305, where registration information can be adjusted in accordance to the new service terms. Additionally, other requestors can receive Web services from the provider, causing the method to loop to step 305, where the other requestors can register with the provider.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method for providing usage-based Web services comprising the steps of:
before providing a Web service, identifying a desired usage level at which the Web service is to be provided to a requestor;
receiving a request for the Web service from the requestor;
determining resources necessary to achieve the usage level; and
responsively providing the Web service in a dynamic fashion based upon the usage level.

2. The method of claim 1, further comprising the step of:
charging the requestor for the Web service based at least in part upon the usage level.

3. The method of claim 1, further comprising the step of:
allocating resources for handling the request at the usage level, wherein the Web service is provided using the allocated resources.

4. The method of claim 3, further comprising the steps of:
analyzing resource consumption for handling the request;
determining that more resources are being consumed than were allocated; and
responsively restricting resource consumption.

5. The method of claim 4, further comprising the step of:
preventing a denial of service attack with said restricting step.

6. The method of claim 1, further comprising the steps of:
ascertaining resources that are available for handling requests; and
adjusting at least one of the usage level at which the Web service is provided and a quantity of available resources based upon the determining and ascertaining steps.

7. The method of claim 6, further comprising the step of:
when the usage level is adjusted, responsively adjusting a cost associated with providing the Web service.

8. The method of claim 6, wherein insufficient resources are available for handling the request at the usage level, said method further comprising the step of:
dynamically downgrading the usage level at which the Web service is provided.

9. The method of claim 6, wherein insufficient resources are available for handling the request at the usage level, said method further comprising the step of:
dynamically downgrading the usage levels at which other Web services are provided to free up resources so that the request can be provided at the usage level.

10. The method of claim 6, wherein insufficient resources are available for handling the request at the usage level, said method further comprising the step of:
dynamically acquiring additional resources so that the request can be provided at the usage level.

11. The method of claim 6, wherein a surplus of resources are available for handling the request, said method further comprising the step of:
dynamically upgrading the usage level at which the Web service is provided.

12. The method of claim 6, wherein the identifying step is part of a registration process, and wherein a determination is made that insufficient resources exist to handle Web services for the requestor a significant period before services are to be provided, and wherein said adjusting step expands an infrastructure so that resources will be available for the requestor when needed.

13. The method of claim 1, further comprising the step of:
comparing resource usage patterns of the requestor against the usage level; and
charging the requestor based upon the comparing step.

14. A machine-readable storage having stored thereon, a computer program having a plurality of code sections, said code sections executable by a machine for causing the machine to perform the steps of:
before providing a Web service, identifying a desired usage level at which the Web service is to be provided to a requestor;
receiving a request for the Web service from the requestor;
determining resources necessary to achieve the usage level;
responsively providing the Web service in a dynamic fashion based upon the usage level; and
charging the requestor for the Web service based at least in part upon the usage level.

15. The machine-readable storage of claim 14, further causing the machine to perform the steps of:
allocating resources for handling the request at the usage level, wherein the Web service is provided using the allocated resources;
analyzing resource consumption for handling the request;
comparing the resource consumption to the resource allocation; and
adjusting at least one of usage level and resource availability responsive to the comparing step.

16. The machine-readable storage of claim 14, further causing the machine to perform the steps of:
ascertaining resources that are available for handling requests; and
adjusting at least one of the usage level at which the Web service is provided and a quantity of available resources based upon the determining and ascertaining steps.

17. The machine-readable storage of claim 14, further causing the machine to perform the steps of:
when the usage level is adjusted, responsively adjusting a cost associated with providing the Web service.

18. A system for providing usage-based Web services comprising:
a plurality of resources used to provide Web services;
a registrar configured to register users before providing Web services to the users, wherein each user is required to specify a usage level during registration; and
a usage tracker configured to compare resources consumed by users against corresponding usage levels, wherein a cost for using the Web services depends upon the usage level of the user.

19. The system of claim 18, further comprising:
a usage allocation engine configured to allocate resources to users based at least in part upon user usage levels.

20. The system of claim 18, further comprising:
means for dynamically adjusting user usage levels based upon resource availability.
